(19) United States
(12) Patent Application Publication
(10) Pub. No.: US 2023/0012104 A1
(43) Pub. Date: Jan. 12, 2023

(54) POWER SUPPLY DEVICE AND INFORMATION PROCESSING DEVICE

(71) Applicant: FUJITSU LIMITED, Kawasaki-shi (JP)

(72) Inventor: EIJI WAJIMA, Ebina (JP)

(73) Assignee: FUJITSU LIMITED, Kawasaki-shi (JP)

(21) Appl. No.: 17/719,420

(22) Filed: Apr. 13, 2022

(30) Foreign Application Priority Data
Jul. 9, 2021 (JP) 2021-113920

(51) Int. Cl. H02M 3/158; G06F 1/26

(52) U.S. Cl. CPC H02M 3/158; G06F 1/26

(57) ABSTRACT

A power supply device includes: a power supply circuit configured to operate with reference to a second ground connected to a first ground via a common ground and output a direct current (DC) voltage between the first ground and an output line; and a sensing circuit configured to sense a first potential difference between the first ground and the second ground, wherein the power supply circuit adjusts the DC voltage according to the first potential difference sensed by the sensing circuit.

### CROSS-REFERENCE TO RELATED APPLICATION

This application is based upon and claims the benefit of priority of the prior Japanese Patent Application No. 2021-113920, filed on Jul. 9, 2021, the entire contents of which are incorporated herein by reference.

### FIELD

The present disclosure discussed herein is related to a power supply device and an information processing device.

### BACKGROUND

A power supply system has been known that includes a point of load (POL) converter for supplying power with a low voltage and a large current to a load.

Japanese Laid-open Patent Publication No. 2007-49822 is disclosed as related art.

### SUMMARY

According to an aspect of the embodiments, a power supply device includes: a power supply circuit configured to operate with reference to a second ground connected to a first ground via a common ground and output a direct current (DC) voltage between the first ground and an output line; and a sensing circuit configured to sense a first potential difference between the first ground and the second ground, wherein the power supply circuit adjusts the DC voltage according to the first potential difference sensed by the sensing circuit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration of a power supply device according to an embodiment;

FIG. 2 is a diagram illustrating an application example of the power supply device according to the embodiment;

FIG. 3 is a diagram illustrating an example of an effect of fluctuation of an AGND on a digital signal;

FIG. 4 is a time chart for explaining an example of the effect of the fluctuation of the AGND on the digital signal;

FIG. 5 is a diagram for explaining an example of the effect of the fluctuation of the AGND on an analog signal;

FIG. 6 is a time chart for explaining an example of the effect of the fluctuation of the AGND on the analog signal;

FIG. 7 is a diagram illustrating an exemplary configuration of a converter; and

FIG. 8 is a diagram illustrating an exemplary configuration of a sensing circuit.

### DESCRIPTION OF EMBODIMENTS

However, if a potential difference between both grounds increases due to a current flowing between a ground of a load and a ground of a power supply circuit such as a POL converter, there is a case where accuracy of a direct current (DC) voltage to be applied to the load decreases.

The present disclosure provides a power supply device that can suppress a decrease in accuracy of a DC voltage applied to a load.

Hereinafter, an embodiment will be described.

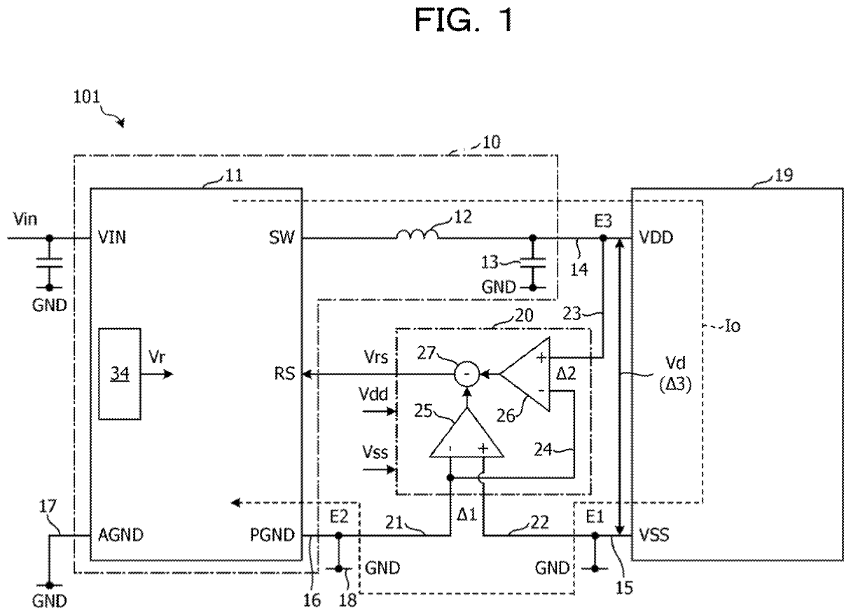

FIG. 1 is a diagram illustrating an exemplary configuration of a power supply device according to an embodiment. A power supply device 101 illustrated in FIG. 1 generates a direct current (DC) voltage Vd to be applied to a load 19. The power supply device 101 is, for example, provided in an electronic device including the load 19. The power supply device 101 may also be built in or externally attached to the corresponding electronic device.

The electronic device includes the load 19 and the power supply device 101. While specific examples of the electronic device include a supercomputer, a server, a personal computer, a mobile terminal device, and the like, the electronic device is not limited to those devices.

The load 19 operates using the DC voltage Vd generated by the power supply device 101 as a power supply voltage. The load 19 may also be a single element and may also be a circuit block including a plurality of elements. Specific examples of the load 19 include semiconductor devices such as a processor, a central processing unit (CPU), a field programmable gate array (FPGA), an application specific integrated circuit (ASIC), a microcomputer, or a memory. However, the load 19 is not limited to these integrated circuits.

The power supply device 101 includes a power supply circuit 10 and a sensing circuit 20.

The power supply circuit 10 operates with reference to a power ground 16 connected to a load ground 15 via a common ground 18 and outputs the DC voltage Vd between the load ground 15 and an output line 14. The common ground 18 is a ground (GND) connected to the power ground 16 of the power supply circuit 10 and the load ground 15 of the load 19 and is, for example, a ground pattern formed on a substrate (not illustrated).

The load ground 15 is an example of a first ground and is, for example, a first ground pattern formed on a substrate (not illustrated). The load ground 15 is, for example, connected to a ground terminal VSS of the load 19. The power ground 16 is an example of a second ground and is, for example, a second ground pattern formed on a substrate (not illustrated). The power ground 16 is, for example, connected to a power ground terminal PGND of a converter 11.

The power supply circuit 10 illustrated in FIG. 1 includes the converter 11, an inductor 12, and a capacitor 13. The converter 11 includes, for example, a switching circuit that performs conversion for stepping down or up a DC input voltage Vin and supplies a switching voltage output from the corresponding switching circuit to the inductor 12. The switching voltage is converted into the DC voltage Vd by the inductor 12 and the capacitor 13.

The converter 11 is, for example, an integrated circuit including an input terminal VIN, an output terminal SW, a signal ground terminal AGND, the power ground terminal PGND, and a remote sense terminal RS. The input voltage Vin is input to the input terminal VIN. The output terminal SW outputs the switching voltage and is connected to one end of the inductor 12. The other end of the inductor 12 is connected to one end of the capacitor 13 and connected to a power supply terminal VDD of the load 19 via the output line 14. The capacitor 13 is a capacitive element connected between the output line 14 and the common ground 18 (GND). The signal ground terminal AGND is connected to the common ground 18 via a signal ground 17. The power ground terminal PGND is connected to the common ground 18 via the power ground 16. The remote sense terminal RS is connected to the sensing circuit 20.

The sensing circuit 20 senses a potential difference Δ1 between the load ground 15 and the power ground 16. The potential difference Δ1 is an example of a first potential difference. The potential difference Δ1 corresponds to a difference between a potential E1 of the load ground 15 and a potential E2 of the power ground 16. In the example illustrated in FIG. 1, the sensing circuit 20 senses the potential difference Δ1 via a sensing line 22 connected to the load ground 15 and a sensing line 21 connected to the power ground 16.

Since the load ground 15 and the power ground 16 are connected via the common ground 18, if a current flowing through the common ground 18 is relatively small, the power ground 16 has a potential substantially the same as the load ground 15. Therefore, if the current flowing through the common ground 18 is relatively small, the converter 11 of the power supply circuit 10 can monitor a voltage between the output line 14 and the power ground 16 as the DC voltage Vd between the load ground 15 and the output line 14. However, if the potential difference Δ1 between the load ground 15 and the power ground 16 increases due to the current flowing through the common ground 18, monitoring accuracy of the DC voltage Vd decreases with a configuration for monitoring the voltage between the output line 14 and the power ground 16. As a result, in a case where feedback control for adjusting the DC voltage Vd on the basis of a monitoring result of the DC voltage Vd is performed, there is a possibility that accuracy of the DC voltage Vd to be applied to the load 19 decreases.

The power supply circuit 10 according to the present embodiment adjusts the DC voltage Vd output between the load ground 15 and the output line 14 according to the potential difference Δ1 sensed by the sensing circuit 20. As a result, even if the potential difference Δ1 increases due to the current flowing through the common ground 18, the power supply circuit 10 can correct the DC voltage Vd according to the sensed potential difference Δ1. Therefore, the decrease in the accuracy of the DC voltage Vd to be applied to the load 19 can be suppressed.

The sensing circuit 20 may also sense a potential difference Δ2 between the output line 14 and the power ground 16. The potential difference Δ2 is an example of a second potential difference. The potential difference Δ2 corresponds to a difference between a potential E3 of the output line 14 and the potential E2 of the power ground 16. In the example illustrated in FIG. 1, the sensing circuit 20 senses the potential difference Δ2 via a sensing line 23 connected to the output line 14 and a sensing line 24 connected to the power ground 16. The power supply circuit 10 may also adjust the DC voltage Vd according to the potential differences Δ1 and Δ2 sensed by the sensing circuit 20. As a result, even if the potential difference Δ1 increases due to the current flowing through the common ground 18, the power supply circuit 10 can correct the DC voltage Vd according to the sensed potential differences Δ1 and Δ2. Therefore, the decrease in the accuracy of the DC voltage Vd to be applied to the load 19 can be suppressed.

The sensing circuit 20 may also sense a potential difference Δ3 between the output line 14 and the load ground 15 by subtracting the potential difference Δ1 sensed by the sensing circuit 20 from the potential difference Δ2 sensed by the sensing circuit 20. The potential difference Δ3 is an example of a third potential difference. The potential difference Δ3 corresponds to a difference between the potential E3 of the output line 14 and the potential E1 of the load ground 15. The sensing circuit 20 feeds back a signal Vrs according to the sensed potential difference Δ3 to the remote sense terminal RS of the converter 11 of the power supply circuit 10. The power supply circuit 10 may also adjust the DC voltage Vd according to the potential difference Δ3 sensed by the sensing circuit 20. As a result, even if the potential difference Δ1 increases due to the current flowing through the common ground 18, it is possible to sense the potential difference Δ3 (that is, for example, DC voltage Vd) with high accuracy. Therefore, the power supply circuit 10 can adjust the DC voltage Vd to be applied to the load 19 with high accuracy.

The power supply circuit 10 adjusts the DC voltage Vd so as to reduce a deviation Ae between the potential difference Δ3 sensed by the sensing circuit 20 and a target voltage Vr. As a result, the DC voltage Vd can be accurately approached to the target voltage Vr. For example, the converter 11 of the power supply circuit 10 generates a pulse width modulation (PWM) signal that converges the deviation Ae between the potential difference Δ3 acquired by the signal Vrs input to the remote sense terminal RS and a predetermined target voltage Vr to zero through PI control or the like. P of the PI control represents proportional control, and I represents integral control. The converter 11 can adjust the DC voltage Vd to the target voltage Vr with high accuracy by controlling the switching circuit described above with the generated PWM signal.

The power supply circuit 10 includes, for example, a target voltage generation circuit 34 that generates the target voltage Vr. The target voltage generation circuit 34 operates with reference to the signal ground 17 connected to have the same potential as the common ground 18. The signal ground 17 is an example of a third ground. In this way, the signal ground 17 is connected to the common ground 18 without floating. As a result, even if a current flows through the common ground 18, fluctuation of the potential of the signal ground 17 can be suppressed as compared with a configuration (not illustrated) in which the signal ground 17 is floating-connected to the common ground 18. As a result, a malfunction of the target voltage generation circuit 34 that operates with reference to the signal ground 17 can be prevented.

The sensing circuit 20 includes operational amplifiers 25 and 26 and a subtractor 27. The sensing circuit 20 (more specifically, operational amplifiers 25 and 26 and subtractor 27) operates at a power supply voltage between a positive voltage Vdd and a negative voltage Vss. The operational amplifier 25 is an example of a first amplifier and senses the potential difference Δ1. The operational amplifier 25 includes an inverting input unit connected to the sensing line 21, a non-inverting input unit connected to the sensing line 22, and an output unit connected to the subtractor 27. The operational amplifier 26 is an example of a second amplifier and senses the potential difference Δ2. The operational amplifier 26 includes a non-inverting input unit connected to the sensing line 23, an inverting input unit connected to the sensing line 24, and an output unit connected to the subtractor 27. The subtractor 27 outputs the signal Vrs according to the potential difference Δ3 by subtracting an output signal of the operational amplifier 25 from an output signal of the operational amplifier 26. The power supply circuit 10 can adjust the DC voltage Vd with high accuracy by adjusting the DC voltage Vd by the converter 11 according to the signal Vrs.

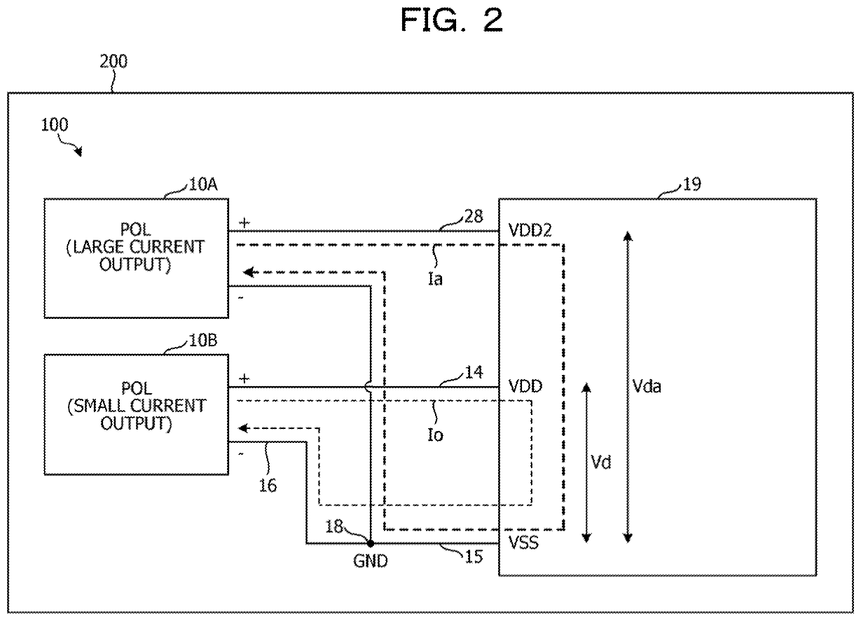

FIG. 2 is a diagram illustrating an application example of the power supply device according to the embodiment. A power supply device 100 illustrated in FIG. 2 is a circuit that generates a plurality of output voltages having different voltage values and supplies the output voltages to a load 19. The load 19 includes a load ground terminal VSS connected to a load ground 15, a power supply terminal VDD connected to an output line 14, and a power supply terminal VDD2 connected to an output line 28. The output line 14 is an example of a first output line, and the output line 28 is an example of a second output line.

The power supply device 100 is, for example, included in an information processing device 200 including the load 19. The information processing device 200 is an example of an electronic device, and specific examples thereof include a supercomputer, a server, a personal computer, or the like.

The power supply device 100 includes power supply circuits 10A and 10B. The power supply circuit 10B generates a DC voltage Vd and outputs the DC voltage Vd between the load ground 15 and the output line 14. As a result, the DC voltage Vd is applied between the load ground terminal VSS and the power supply terminal VDD. The power supply circuit 10A generates a DC voltage Vda higher than the DC voltage Vd and outputs the DC voltage Vda between the load ground 15 and the output line 28. As a result, the DC voltage Vda is applied between the load ground terminal VSS and a power supply terminal VDD2. The power supply circuit 10B is an example of a first power supply circuit, and the power supply circuit 10A is an example of a second power supply circuit.

A direct current (DC) la that is flowed through the output line 28 by the power supply circuit 10A flows to the load ground 15 via an internal circuit of the load 19. When the DC la flows to the load ground 15, a potential difference is caused between the load ground 15 and the power ground 16. Therefore, as described above, the accuracy of the DC voltage Vd decreases. By providing the above-described sensing circuit 20 that senses the potential difference Δ1 between the load ground 15 and the power ground 16 in the power supply circuit 10B, the decrease in the accuracy of the DC voltage Vd can be suppressed. Furthermore, by providing the above-described sensing circuit 20 that senses the potential difference Δ1 between the load ground 15 and the power ground 16 in the power supply circuit 10A, the decrease in the accuracy of the DC voltage Vda can be suppressed.

When the DC la flowed through the output line 28 by the power supply circuit 10A is larger than a DC Io flowed through the output line 14 by the power supply circuit 10B, a voltage drop caused by flowing the DC la to the load ground 15 is further increased. Therefore, in a case where the DC la is larger than the DC Io, an effect for suppressing the decrease in the accuracy of the DC voltage Vd is further enhanced by providing the sensing circuit 20 described above that senses the potential difference Δ1 between the load ground 15 and the power ground 16 in the power supply circuit 10B.

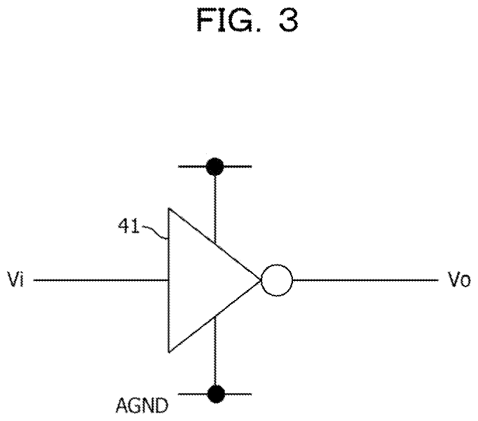

FIG. 3 is a diagram for explaining an example of an effect of fluctuation of an AGND on a digital signal. A logic circuit 41 is an example of an internal circuit of the converter 11 of the power supply circuit 10 and operates with reference to the signal ground 17 (AGND). The logic circuit 41 is, for example, a component such as a protection circuit (not illustrated) or the target voltage generation circuit 34 illustrated in FIG. 1. The logic circuit 41 illustrated in FIG. 3 is an inverter that converts an input signal Vi into an output signal Vo.

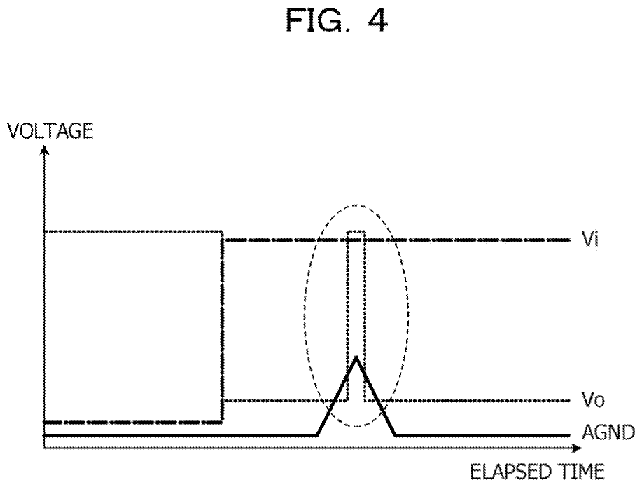

FIG. 4 is a time chart for explaining an example of the effect of the fluctuation of the AGND on the digital signal. When the AGND fluctuates, there is a possibility that a malfunction in which the output signal Vo is inverted occurs. According to the power supply device 101 illustrated in FIG. 1, the signal ground 17 is connected to the common ground 18 without floating. Because this can suppress the fluctuation of the AGND, it is possible to prevent the occurrence of the malfunction such as the inversion of the output signal Vo.

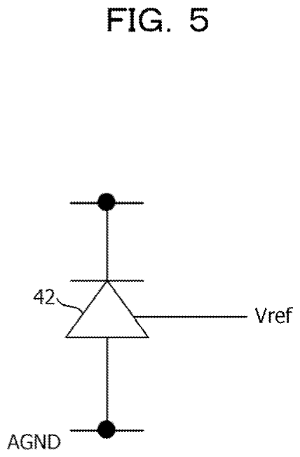

FIG. 5 is a diagram for explaining an example of an effect of the fluctuation of the AGND on an analog signal. A reference voltage generation circuit 42 is an example of the internal circuit of the converter 11 of the power supply circuit 10 and operates with reference to the signal ground 17 (AGND). The reference voltage generation circuit 42 generates an analog reference voltage Vref. The reference voltage Vref serves as a reference of generation of the target voltage Vr described above, an overcurrent detection threshold, an overvoltage detection threshold, or the like.

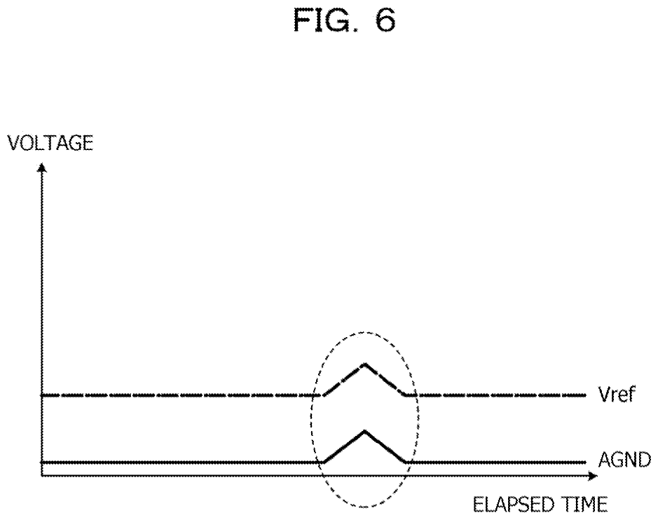

FIG. 6 is a time chart for explaining an example of the effect of the fluctuation of the AGND on the analog signal. When the AGND fluctuates, there is a possibility that a malfunction in which the reference voltage Vref fluctuates occurs. According to the power supply device 101 illustrated in FIG. 1, the signal ground 17 is connected to the common ground 18 without floating. Because this can suppress the fluctuation of the AGND, it is possible to suppress the occurrence of the malfunction such as the fluctuation of the reference voltage Vref.

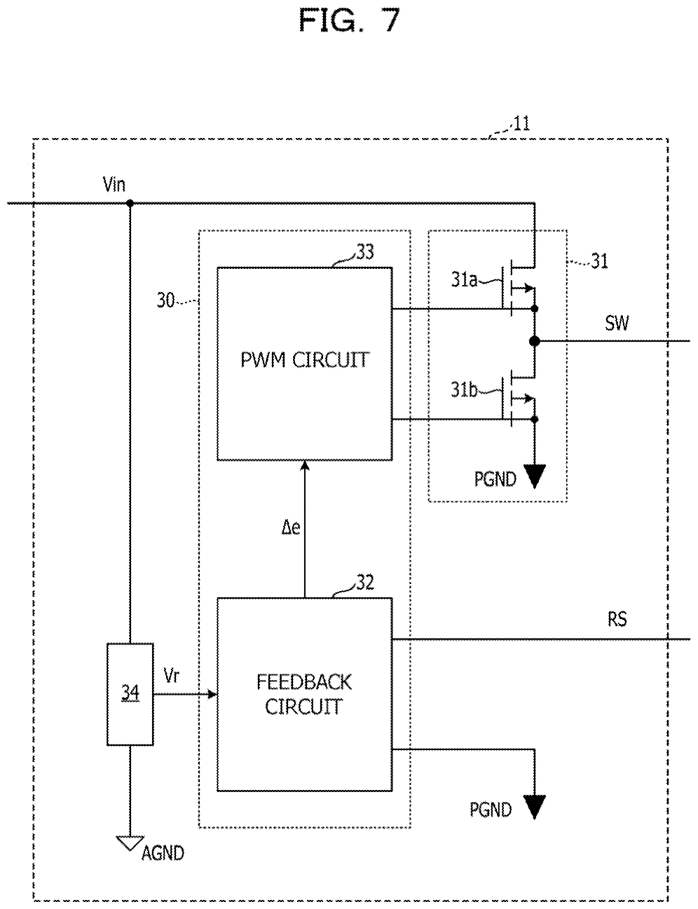

FIG. 7 is a diagram illustrating an exemplary configuration of a converter. The converter 11 includes a control circuit 30, a switching circuit 31, and the target voltage generation circuit 34. The control circuit 30 controls the switching circuit 31 so as to generate the DC voltage Vd to be applied to the load 19 described above according to the signal Vrs input to the remote sense terminal RS. The switching circuit 31 includes a high-side switching element 31a and a low-side switching element 31b. A connection point between the switching elements 31a and 31b is connected to a switch terminal SW. The control circuit 30 and the switching circuit 31 operate with reference to the power ground 16 (PGND).

The control circuit 30 includes a feedback circuit 32 and a pulse width modulation (PWM) circuit 33. The feedback circuit 32 outputs the deviation Ae between the potential difference Δ3 acquired according to the signal Vrs input to the remote sense terminal RS and the target voltage Vr. The PWM circuit 33 drives the switching circuit 31 at a duty ratio according to the deviation Ae. As a result, the DC voltage Vd can be approached to the target voltage Vr.

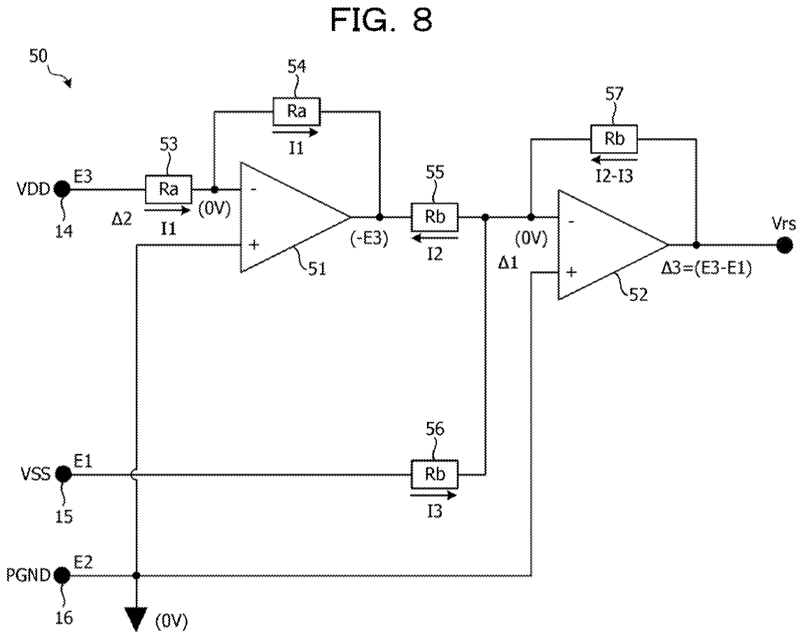

FIG. 8 is a diagram illustrating an exemplary configuration of a sensing circuit and illustrates an exemplary configuration different from the sensing circuit 20 illustrated in FIG. 1. A sensing circuit 50 illustrated in FIG. 8 includes operational amplifiers 51 and 52 and resistors 53 to 57. The operational amplifier 51 is an example of the first amplifier and senses the potential difference Δ2. The operational amplifier 51 includes a non-inverting input unit connected to the power ground 16, an inverting input unit connected to the output line 14 via the resistor 53, and an output unit connected to the inverting input unit via the resistor 54. The operational amplifier 52 is an example of the second amplifier and senses the potential difference Δ1. The operational amplifier 52 includes a non-inverting input unit connected to the power ground 16, an inverting input unit connected to the output unit of the operational amplifier 51 via the resistor 55 and to the load ground 15 via the resistor 56, and an output unit connected to the inverting input unit via the resistor 57. Each of the resistors 53 and 54 has a resistance value Ra. Each of the resistors 55, 56, and 57 has a resistance value Rb.

With such a circuit configuration, the sensing circuit 50 can output a signal Vrs according to the potential difference Δ3 obtained by subtracting the potential difference Δ1 from the potential difference Δ2 from the operational amplifier 52.

Although the embodiment has been described above, the technique of the present disclosure is not limited to the embodiment described above. Various modifications and improvements such as combination and replacement with some or all of other embodiments may be allowed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A power supply device comprising:
a power supply circuit configured to operate with reference to a second ground connected to a first ground via a common ground and output a direct current (DC) voltage between the first ground and an output line; and
a sensing circuit configured to sense a first potential difference between the first ground and the second ground, wherein
the power supply circuit adjusts the DC voltage according to the first potential difference sensed by the sensing circuit.

2. The power supply device according to claim 1, wherein
the sensing circuit senses a second potential difference between the output line and the second ground, and
the power supply circuit adjusts the DC voltage according to the first potential difference and the second potential difference sensed by the sensing circuit.

3. The power supply device according to claim 2, wherein
the sensing circuit senses a third potential difference between the output line and the first ground by subtracting the first potential difference from the second potential difference, and
the power supply circuit adjusts the DC voltage according to the third potential difference sensed by the sensing circuit.

4. The power supply device according to claim 3, wherein the power supply circuit adjusts the DC voltage so as to reduce a deviation between the third potential difference sensed by the sensing circuit and a target voltage.

5. The power supply device according to claim 4, wherein
the power supply circuit includes a target voltage generation circuit that generates the target voltage, and
the target voltage generation circuit operates with reference to a third ground connected to have a potential same as the common ground.

6. The power supply device according to claim 3, wherein
the sensing circuit includes
a first amplifier that senses the first potential difference,
a second amplifier that senses the second potential difference, and
a subtractor that outputs a signal according to the third potential difference by subtracting an output signal of the first amplifier from an output signal of the second amplifier.

7. The power supply device according to claim 3, wherein
the sensing circuit includes
a first amplifier that senses the second potential difference, and
a second amplifier that senses the first potential difference, and
the second amplifier includes an inverting input unit to which an output of the first amplifier is input and outputs a signal according to the third potential difference.

8. The power supply device according to claim 1, further comprising:
a second power supply circuit configured to output a second DC voltage between the first ground and a second output line, wherein
a direct current (DC) flowed through the second output line by the second power supply circuit flows through the first ground.

9. The power supply device according to claim 8, wherein the DC flowed through the second output line by the second power supply circuit is more than a DC flowed through the output line by the power supply circuit.

10. The power supply device according to claim 1, wherein the power supply circuit adjusts the DC voltage by a converter that operates with reference to the second ground.

11. An information processing device comprising:
a power supply device; and
a load coupled the power supply device,
wherein the power supply device includes:
a power supply circuit configured to operate with reference to a second ground connected to a first ground via a common ground and output a direct current (DC) voltage between the first ground and an output line; and
a sensing circuit configured to sense a first potential difference between the first ground and the second ground,
wherein the power supply circuit adjusts the DC voltage according to the first potential difference sensed by the sensing circuit.
